(19) United States
(12) Patent Application Publication
(10) Pub. No.: US 2004/0108176 A1
(43) Pub. Date: Jun. 10, 2004

(54) Anti-rattle spring clip

(75) Inventors: John Thomas, Livonia, MI (US); Joseph Grabowski, Dearborn, MI (US); Scott Lutteke, Troy, MI (US); Jeffrey Bonser, Livonia, MI (US)

Correspondence Address: Ralph E. Smith, DaimlerChrysler Intellectual Capital Corporation, 800 Chrysler Drive, CIMS 483-02-19, Auburn Hills, MI, 48326-2757, US

(73) Assignee: DaimlerChrysler Corporation

(21) Appl. No.: 10/310,731

(22) Filed: Dec. 5, 2002

(51) Int. Cl. F16D 65/40

(52) U.S. Cl. 188/73.38

(57) ABSTRACT

An anti-rattle includes an arrangement configured to couple to a disk brake caliper and a curved spring section that is configured to compress in response to a rattling of the caliper towards the clip, reducing the impact energy of the rattling.

### FIELD OF THE INVENTION

The present invention relates generally to motor vehicle brake systems. More particularly, the present invention relates to an anti-rattle clip for preventing rattling or vibrations between calipers and anchor bracket rails used in disk brake systems.

### BACKGROUND INFORMATION

FIG. 1 shows a side elevation of a conventional rear wheel disk brake manifold 5. The manifold 5 includes a disk rotor 10, a backing plate 15 adjacent to the rotor, and a brake anchor 20 that affixes and supports both the backing plate and rotor. The brake anchor includes two arm sections 23, 24 between which a brake caliper 30 is positioned. The brake caliper is coupled to a hydraulic system that can effectuate braking of a vehicle by applying pressure to brake pads 35, 36 which in turn press against the brake rotor 10, forcing it into contact with the wheel. The anchor arms 23, 24 include bracket rails 27, 28 at their inner ends facing the caliper 30 that abut against and overhang the outer edge of the brake rotor 10. Many disk brakes designs include bracket slippers 41, 42 which may be stamped components fitted to the ends of the bracket rails 27, 28 used to protect the anchor bracket rails from wear due to contact with the brake rotor 10.

The conventional manifold design depicted in FIG. 1 may suffer from a vibration or rattling of the caliper in a circumferential direction towards and away from the respective anchor bracket rails 27, 28 and bracket slippers 41, 42 during movement of the vehicle. Over time, the rattling may damage both the slippers 41, 42 and the anchor bracket rails 27, 28 which may necessitate a costly repair operation.

It is therefore an object of the present invention to provide an anti-rattle spring clip in the brake manifold to prevent rattling of the caliper against the anchor brackets.

### SUMMARY

The above and other beneficial objects of the present invention are most effectively attained by providing an anti-rattle clip for a disk brake as described herein. In an example embodiment, the anti-rattle according to the present invention includes an arrangement configured to couple to a disk brake caliper and a curved spring section that is configured to compress in response to a rattling of the caliper towards the clip, reducing the impact energy of the rattling.

### BRIEF DESCRIPTION OF THE DRAWINGS

In the accompanying drawings:

FIG. 1 shows a side elevation of a conventional disk brake manifold for a wheel;

FIG. 2 is a side view of an anti-rattle clip according to an example embodiment of the present invention;

FIG. 3 is a perspective view showing an example embodiment of an anti-rattle clip according to the present invention atop an anchor bracket rail;

FIG. 4 shows a side elevation of a disk brake manifold with caliper and brake pads removed and illustrating an example configuration of the anti-rattle clip according to the present invention with respect to the brake manifold; and

FIG. 5 shows a side elevation of the disk brake manifold of FIG. 4 including the caliper and brake pads and illustrating an example configuration of the anti-rattle clip according to the present invention with respect to the caliper.

### DETAILED DESCRIPTION

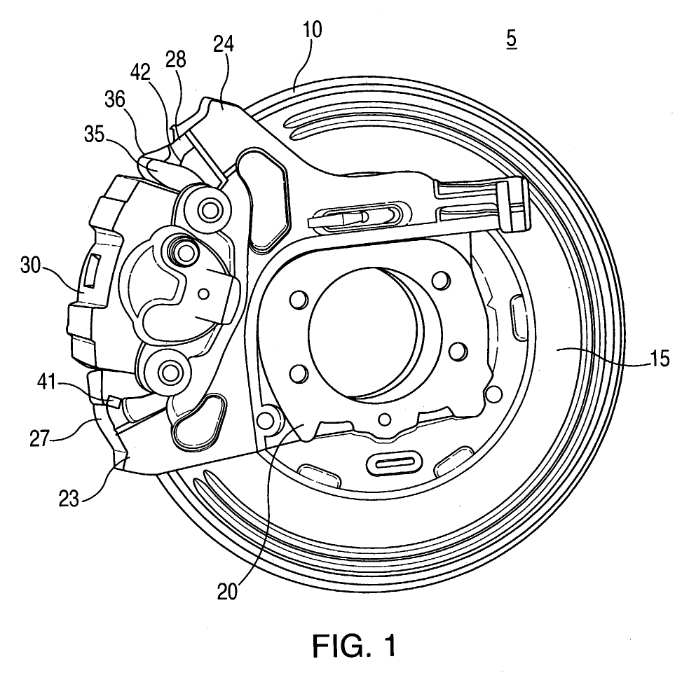

Those skilled in the art will gain an appreciation of the present invention from a reading of the following description when viewed in conjunction with the accompanying drawings of FIGS. 1 to 5, inclusive. The individual reference characters designate the same or similar elements throughout the several views.

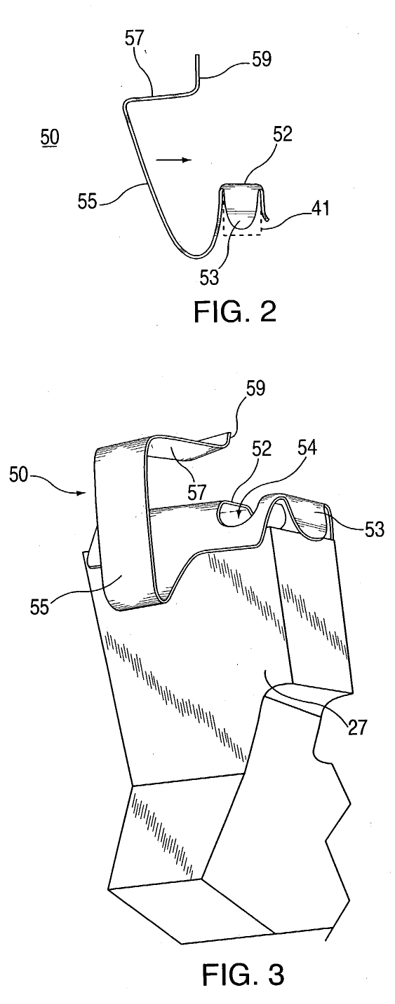

Referring now to FIG. 2, there is shown a side view of an example embodiment of an anti-rattle clip 50 according to the present invention. The clip 50 may be a stamped metal form from a particularly strong stainless steel, e.g., “half-hard” stainless steel which provides extra strength and corrosion resistance. The clip includes a receptacle having a first partially planar section 52 and end flaps 53 configured for engagement onto one of the bracket slippers 41, 42. The planar section 52 comes into contact with a leading edge of the caliper 30 when the caliper rattles in the direction of the bracket rail 41. According to an example embodiment, the clip 50 and the bracket slipper 41 may be integrated and constitute a single stamped component. The clip 50 also includes a curved section 55 that is configured to compress in response to rattling of the caliper towards the bracket rail 27 and to dampen the movement of the caliper by absorbing a portion of its kinetic energy. Clip section 57 is a planar section directed radially toward the manifold 5 upon which a planar surface of the caliper 30 rests. As the caliper 30 rattles, the movement is transferred to a compressive force on the planar section 57. A short tab section 59 extends perpendicularly from an inner end of the planar section 57 for secure engagement with a groove or opening in the caliper 30.

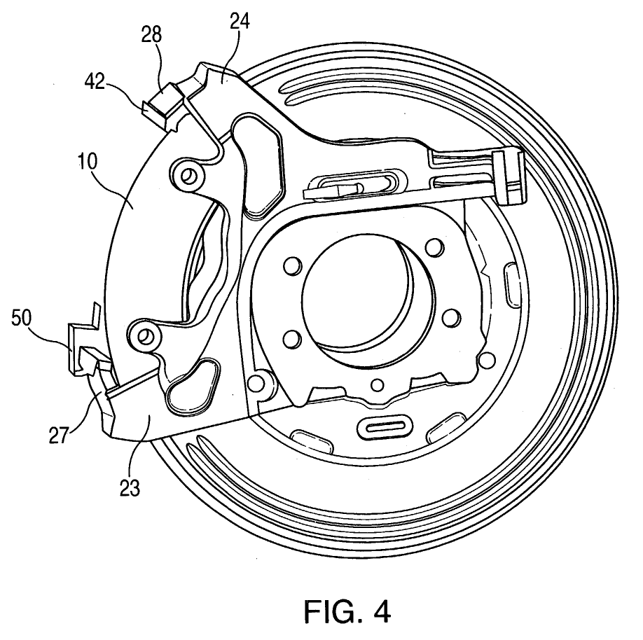

FIG. 3 shows a perspective view of the example embodiment of the anti-rattle clip of the present invention shown in FIG. 2 positioned at the end of an anchor bracket rail. As shown, planar section 52 spans the entire width of the bracket rail 27 of the clip 50. The planar section 52 may not completely cover the rail but rather may include groove sections 54. The curved spring section 55 and the planar section 57 may be narrower than the bracket rail 27 or the planar section, which may improve the flexibility of the curved section 55 and provide for engagement between the planar section 57 and tab 59 and the caliper 30.

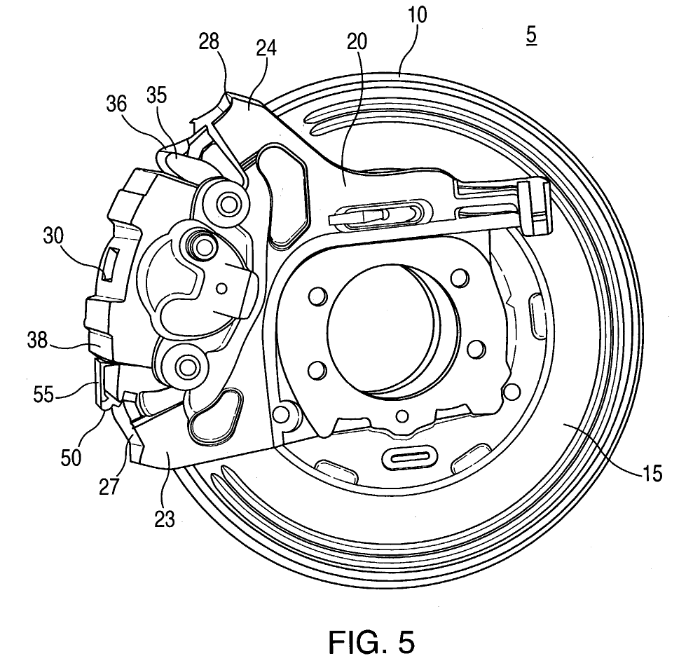

FIG. 4 shows a side elevation of a disk brake manifold with caliper and brake pads removed which illustrates an example configuration of the anti-rattle clip with respect to the brake manifold. As depicted, the anti-rattle clip 50 is integrated with and extends outwardly and upwardly from the lower bracket slipper 41 at the end of the lower anchor bracket rail 27. According to the example embodiment shown, the upper bracket slipper 42 does not include an anti-rattle clip. In this case, the dampening of the caliper 30 rattling performed by the anti-rattle clip 50 of the lower slipper 41 may be sufficient to protect the upper slipper 42 and bracket rail 28 from damaging impacts.

FIG. 5 shows a side elevation of the disk brake manifold of FIG. 4 including the caliper and brake pads that illustrates an example of how the anti-rattle clip 50 according to the present invention engages with the caliper 30. In FIG. 5, the clip 50 is shown in a fully extended position in which it is not compressed by rattling of the caliper 30. As indicated, the curved portion 55 of the clip 50 is in an approximately upright position and the planar section 57 and tab 59 (concealed by a lower surface of the caliper 30) rest under and engage with the bottom edge 38 of the caliper. When the caliper rattles downwardly the curved section 55 distends downwardly and inwardly to absorb the impact energy of the caliper 30. As the caliper rattles upwardly the curved section 55 springs back into the upright position.

Thus, the several aforementioned objects and advantages of the present invention are most effectively attained. Those skilled in the art will appreciate that many modifications of the example embodiments described hereinabove may be made without departing from the spirit and scope of the invention. Although several example embodiments of the invention have been described and disclosed in detail herein, it should be understood that this invention is in no sense limited thereby and that its scope is to be determined by that of the appended claims.

What is claimed is:

1. An anti-rattle clip for a disk brake having a caliper, comprising:
an arrangement configured to couple to the caliper; and
a curved spring section configured to compress in response to a rattling of the caliper toward the clip to reduce impact energy of the rattling.

2. The anti-rattle clip of claim 1, wherein the coupling arrangement includes a planar section configured to abut against a corresponding section of the caliper and a tab section coupled to the planar section for engaging with an opening in the caliper.

3. The anti-rattle clip of claim 1, wherein the disc brake includes an anchor section having at least one bracket rail, each bracket rail having a bracket slipper, the clip integrated with one of the bracket slippers in a single component.

4. The anti-rattle clip of claim 3, further comprising:
a receptacle section configured to tight fittingly couple to an end section of a bracket rail.

5. The anti-rattle clip of claim 4, wherein the curved spring section includes a first end coupled to the receptacle section and a second end coupled to the planar section.

6. The anti-rattle clip of claim 3, wherein the anti-rattle clip includes half-hard stainless steel.

7. A disk brake, comprising:
a disk rotor;
an anchor section including anchor arms, the anchor arms having bracket rails overhanging a circumferential edge portion of the disk rotor, each bracket rail having an end bracket slipper configured to reduce damaging contact between the disk rotor and the bracket rails;
a brake caliper positioned between the anchor arms; and
an anti-rattle clip coupled to one bracket slipper positioned to contact the brake caliper during a rattling and configured to reduce an impact energy of the caliper rattling.

8. The rear disk brake of claim 7, wherein the anti-rattle clip includes an arrangement configured to couple to the caliper and a curved spring section that is configured to compress in response to a rattling of the caliper towards the clip to reduce the impact energy of the rattling.

9. The rear disk brake of claim 8, wherein the anti-rattle clip is integrated with one of the bracket slippers in a single component.

10. The rear disk brake of claim 9, wherein the anti-rattle clip includes half-hard stainless steel.

11. The rear disk brake of claim 9, wherein the anti-raffle clip includes a coupling arrangement having a planar section configured to abut against a corresponding section of the caliper and a tab section coupled to the planar section for engaging with an opening in the caliper.

12. The rear disk brake of claim 11, wherein the anti-rattle clip includes a receptacle section configured to tight fittingly couple to the end section of the bracket rail.
